(19) United States
(12) Patent Application Publication
(10) Pub. No.: US 2007/0104359 A1
(43) Pub. Date: May 10, 2007

(54) Digital inspection of the physical quality of plain surfaces

(76) Inventors: Mauricio Telias, Santiago (CL); Nancy Perez, Santiago (CL); Luis Mujica, Santiago (CL); Leonardo Cornejo, Santiago (CL); David Alvear, Santiago (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/270,822

(22) Filed: Nov. 10, 2005

(51) Int. Cl. G06K 9/00

(52) U.S. Cl. 382/152

(57) ABSTRACT

A method of analysis and automatic visual inspection system has been developed through digital images which operate on-line in the detection of disparities in plain surfaces, preferably plates over a transportation belt. The objective of the system is to classify the surfaces of the plates in surfaces free of disparities and surfaces with disparities. The information necessary to determine the difference between the plates is given by the color and texture of the surface under inspection. The plain surface (2) of the plate, is entirely and homogeneously lit by a Fresnel type spotlight (1). An image of each face of the plate is obtained by digital CCD cameras (3) and (4). This digital signal is sent to a frame buffer in a frame grabber (6). A series of algorithms, for the processing of digital images, enhances the details of the plate's surface image for its further analysis. The final image is analyzed by a processor (5) obtaining an indicative parameter of the physical quality of said plate.

The present application refers to a method for the automatic inspection of the physical quality of plain surfaces, for different types of products, and a system to carry out such method. More specifically, it refers to a method of analysis and automatic visual inspection system to detect imperfections in plain surfaces, preferably in copper cathode surfaces from electro-winning (EW) processes.

### 1. PREVIOUS ART

In every type of industry, the measurement of the surface's texture has become one of the most important points in production process's such as in manufacturing industries and those most related to the quality and reliability of its products. Specifically, for the production of plates, sheets or straps of different material, it is of great utility to count with an on-line sensor to determine their physical quality. The presence of imperfections in these surfaces is a clear indicator of their quality, since their physical aspect and quality are directly related. The correct control of the surface of line products not only reduces production costs, but also reduces the amount of faulty pieces, through a feedback from the quality sensor and the production itself.

In trying to perform this inspection automatically, the methods developed to fulfill this objective and to obtain a texture parameter that can be related to the surface's quality have been various.

A traditional form of surface inspection is through the use of needles, in which their movements is correlated to the surface's profile. These instruments electronically relate the movement of a diamond needle with the texture of the surface under observation. The big disadvantage of these instruments is their need for direct physical contact, which limits the speed of the process. Likewise, the instrument's measurement is based on a limited number of line samples, which may not represent the true characteristics of the surface. Given the low measurement speed, the quality controls based upon such instruments are applied to a reduced number of samples.

Electro-optical devices have been introduced as a better alternative for surface texture measurement without physical contact. In these devices, the amount of light reflected by the surface is measured, for which diode linear arrangements are used as consistent light sources. These systems can ensure a faster inspection, however, they do not provide sufficient information to characterize the surface's topography and texture. Furthermore, many of these systems are for laboratory use and are not recommendable for high speed automatic inspections in production environments.

One of the purposes of the invention is to provide a method for the inspection of plain surfaces which overcomes the previous disadvantages. Another important aspect of the present application is that a system has been developed which carries out the method previously mentioned.

The advantages posed by the invention lie in that a method and system to carry out such method has been developed, which detects and optically analyzes the plain surfaces without physical contact between the analysis system and the analyzed surface, in which such analysis is carried out over the totality of the surface, thus having a global result of the inspected element's quality. Additionally, the analysis is carried out in real time, which means that a procedure of plate fabrication, copper cathodes or other plain surfaces can be fed in the production line and thus greatly diminish fabrication imperfections. This feedback is absolutely representative of the fabrication processes since the proposed method and analysis performs the analysis over the totality of the pieces produced in the process and, also, it has been designed to be implement in any industrial complex which requires to analyze the quality of the plain surfaces of the fabricated products.

### 2. BRIEF DESCRIPTION OF THE DRAWINGS

FIG. 1: represents a scheme of the assembly and lay-out of the system of the present application.

FIG. 2: represents a scheme of the sequence of steps for image classification.

FIG. 3: represents a graphic with the behavior of image brightness elimination.

FIG. 4A: represents an image, before the application of a brightness elimination filter.

FIG. 4B: represents an image, after the application of a brightness elimination filter.

FIG. 5A: represents an image, before the application of the noise elimination filter.

FIG. 5B: represents an image, after the application of the noise elimination filter.

FIG. 6A: represents and image before the enhancement of borders applying the high-pass filter.

FIG. 6B: represents and image after the enhancement of borders applying the high-pass filter.

FIG. 7: represents and image after the application of the above mentioned filters.

FIG. 8: represents a subdivision graphic in lines and columns (I×J) of a given image.

FIG. 9: represents a subdivision graphic of an image provided in subimages, each one of them in I/32×J/32 dimensions.

FIG. 10: represents a three-dimensional graphic of the variation matrix associated to an analyzed surface.

FIG. 11: represents and image of the analyzed surface and which variation is graphically represented in FIG. 10.

### 3. DESCRIPTION OF THE INVENTION

Initially, a system through which the method of analysis of the plain surface qualities through digitized images will be described.

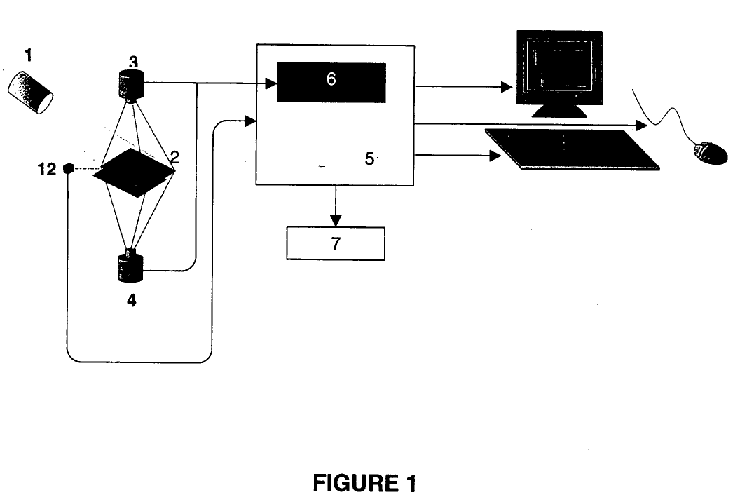

In FIG. 1, we can see the lay-out of all the devices which compose the system for the classification of the surface under inspection.

The system is configured so that a part or the whole surface (2) to be analyzed is lit by a light source (1). The reflected light is captured by a video camera lens (3), in which a digital video camera (3) is preferably used. The camera's output (3) is sent to a processor (5) which carries out the processing and analysis of the image, providing an indicative parameter of the surface texture of a certain copper cathode.

When the system is activated, a position sensor (12) indicates that there is an element located on the inspection site, specifically a copper cathode, which surface (2) will be analyzed, has been placed under a light beam of a luminous source (1). The latter, is preferably a Fresnel type spotlight, used in cinema and television, with the particular feature of being a very directional light source, that produces a great amount of details in the surface (2) over which it impacts. The light beam is directed towards the surface (2) of the copper cathode with an impact angle of approximately 30°, homogeneously illuminating surface (2).

Even though it is not shown in the figure, the light source (1) obviously includes a fitting device of the incidence angle as well as spatial location.

A camera (3) preferably digital, with an adjustable 8-16 mm lens, is assembled over the surface (2) to be inspected, previously adjusting the image of each one to the surface size (2) to be analyzed. The image obtained by this means is a representative digital image of the surface characteristics of the analyzed cathode.

In one example, a Basler A113CP digital camera with high resolution progressive scan was used. This is a color camera with a maximum resolution of 1300×1030 pixels.

The camera has a digital output (a) which is connected to a frame grabber (6) (image capture card), that includes a frame buffer (image storage memory), such frame grabber being inserted inside the processor (5). The digital image is analyzed by a processor (5), which in the tests performed a 300 Mhz, 64 Mb of RAM memory was used, with a monitor, keypad and mouse. The processor's output (5) is a signal (7) which can be sent to a signal processor in the line of production.

During operation, the surface (2) to be inspected must be placed under the camera (3). The light source (1) is adjusted at an angle and distance to obtain maximum performance. The digital signal (a) generated by the camera (3) is sent to the frame grabber (6), storing a 1300×1030 pixel image of 8 bits per pixel (gray scale) in the frame buffer. Each pixel is contained in a byte and represents the light intensity in a given point, in 256 levels, where 0 is the darkest (black) and 255 is the brightest (white).

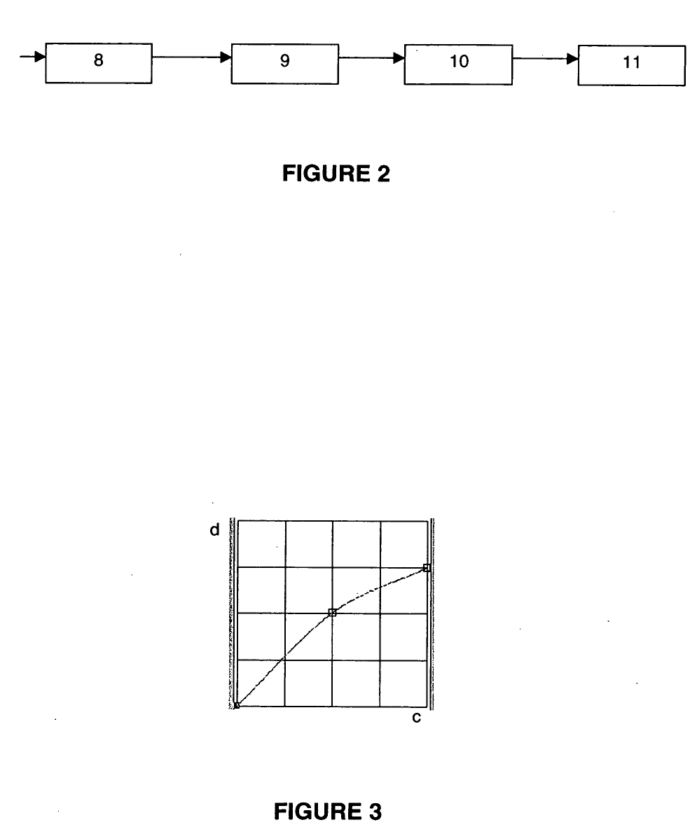

In order to carry out the method of analysis of the images captured by the previously described system, the extraction of characteristics is very important for image classification. The scheme to carry out image classification is shown in FIG. 2.

The first stage, the caption of images (8), is carried out through the system previously described. The second stage of the method corresponds to image enhancement (9), which is the pre-processing performed over the image to enhance the characteristics hoped to extract from the image. The third stage corresponds to the extraction of characteristics (10), which provides the attributes to each image, these values enter into the fourth stage, that of classification (11), which determines the absence or presence of imperfections in the surface (2).

To perform the second and third stage of the method, that is the image enhancement stage (9) and the extraction of characteristics (10), a series of operations have been implemented between images and filters of various types, to enhance the image texture characteristics, which is relevant for the detection of imperfections.

Within the image enhancement stage (9), the following filter application operations have been considered, which are described below:

Image “Brightness” Elimination (High Value Cuts of the Histogram)

In this filter a point by point transformation over the image is applied, modifying the pixel values with respect to the level of gray near the white. For this purpose, a transformation is applied which works linearly up to the level of gray 128 after this value, the behavior is quadratic, so that the maximum values in the filtered image do not exceed 190 in the level of gray, as may be appreciated in the graphic of FIG. 3, in which the input is denominated c and the output d.

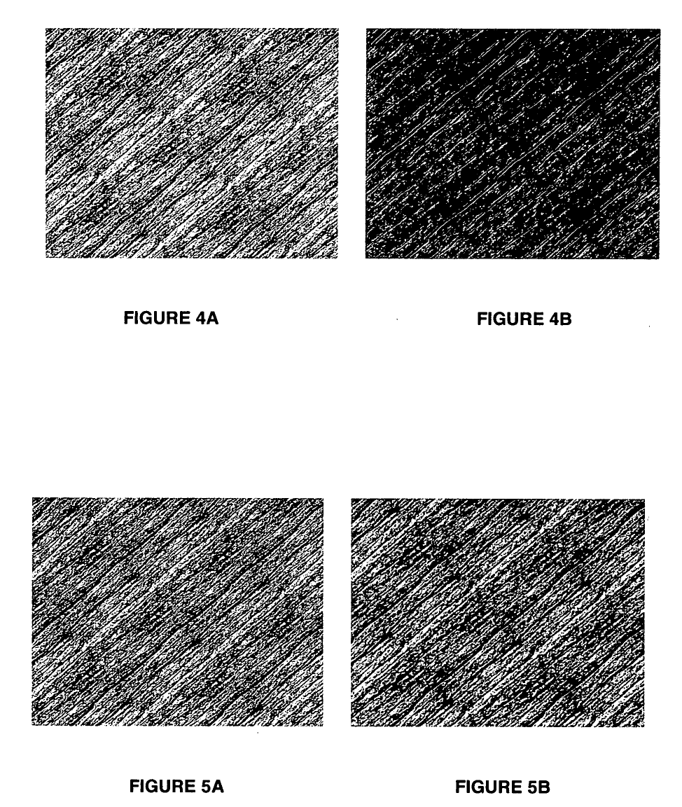

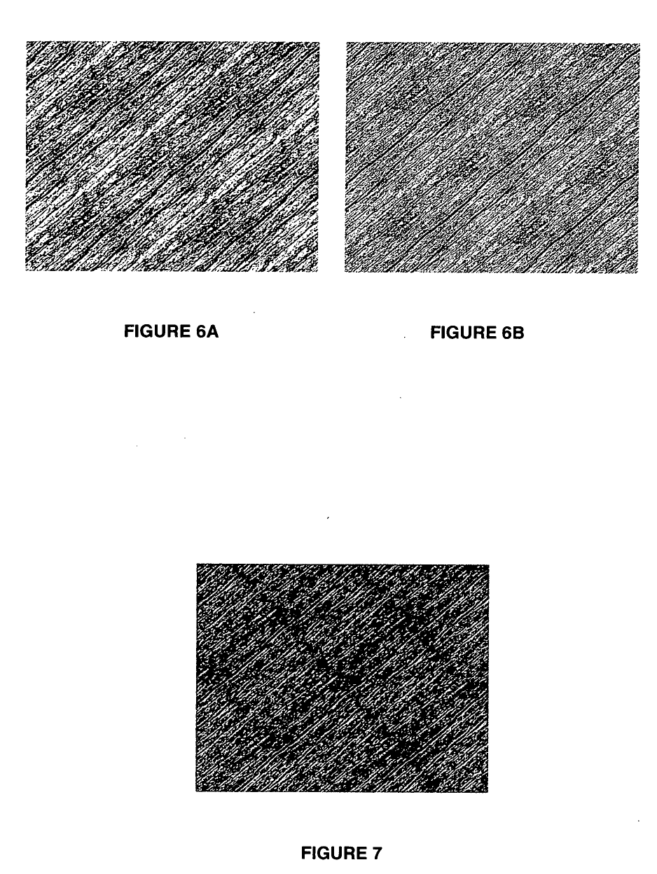

An application example can be observed in the image of FIG. 4B in which the image of FIG. 4A is an image before the brightness elimination filter.

Noise Elimination by Means of Bass-Pass Filter.

The image is convoluted with a square filter of the type

$$LP = \frac{1}{9} [ \begin{matrix}1 & 1 & 1 \\ 1 & 1 & 1 \\ 1 & 1 & 1\end{matrix} ]$$

This filter softens the image taking the local average in a window of 3×3. This softening diminishes the high spatial frequencies, including image noise. The effect of noise elimination can be appreciated in FIG. 5B.

Border Enhancement by Means of High-Pass Filters.

The image is convoluted with a square filter of the type

$$HP = [ \begin{matrix}0 & - 1 & 0 \\ - 1 & 5 & - 1 \\ 0 & - 1 & 0\end{matrix} ]$$

This filter amplifies the high frequencies within the image, giving it an appearance of greater definition.

Applying the filters over the image in cascade, the resulting image over which it is being worked on presents a notorious enhancement of the flaws and imperfections required to be detected. The effect of the image enhancement can be appreciated in FIG. 7.

Starting from filtered images to enhance those characteristics which are important, the extraction of the image energy has been considered as a characteristic capable of providing sufficient information as to the texture of the analyzed image.

The energy quantifies the dispersion of a set of pixels within the image with respect to its average value, using for this purpose the σ/μ indicator, whereby μ and σ represent, respectively, the average and standard deviation of the histogram of the analyzed image, defined in equations 1 and 2.

$$\begin{matrix}μ = \frac{1}{n} {\sum }_{i = 1}^{n} {x}_{i} & Ecuación 1 \\ σ = \sqrt{\frac{1}{n} {\sum }_{i = 1}^{n} {( {x}_{i} - μ )}^{2}} & Ecuación 2\end{matrix}$$

where Xᵢ is the number of pixels in the level gray i, and n=255

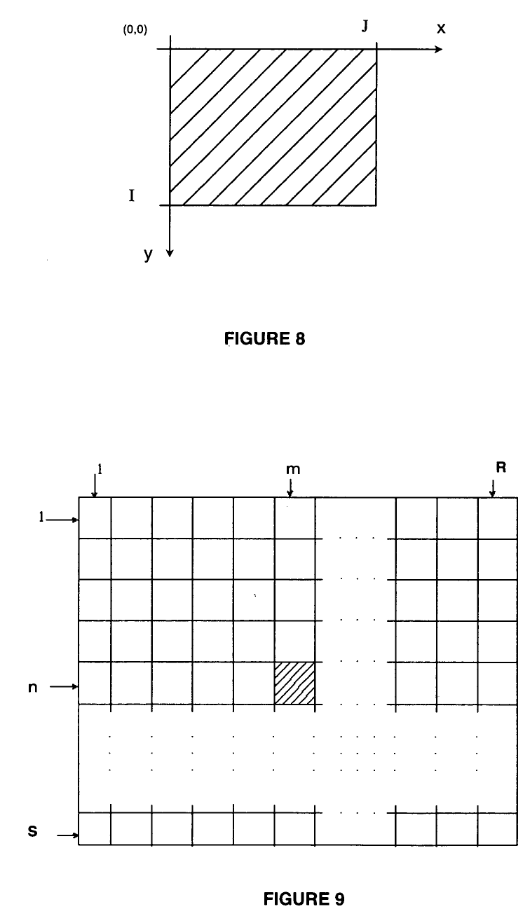

The value of σ/μ is calculated in the image, as shown in equations 3 and 4.

$$\begin{matrix}μ = \frac{1}{IJ} {\sum }_{i = 1}^{I} {\sum }_{j = 1}^{J} {x}_{i , j} & Ecuación 3 \\ σ = \sqrt{\frac{1}{IJ} {\sum }_{i = 1}^{I} {\sum }_{j = 1}^{J} {( {x}_{i , j} - μ )}^{2}} & Ecuación 4\end{matrix}$$

Wherein I and J are the number of pixel rows and columns of the image, as shown in FIG. 8.

With this image, of known I×J dimensions, the variation matrix is constructed, for which the image is divided in S×R subimages, each one of

$$\frac{I}{S} \times \frac{J}{R}$$

dimensions.

In each of these subimages, the σ/μ rate is calculated.

In FIG. 9 the original image divided in S×R parts can be observed, and the subimage of the same in the (m,n) position in which the σ_{m,n}/μ_{m,n} variation rate must be calculated.

Each one of these calculated values is stored in a S×R matrix denominated variation V matrix. The elements of the variation matrix are real and always positive values, since they are the quotient of two real and positive values.

Having the variation matrix, its Bi-dimensional Fourier Transform is calculated in a classical form, since the number of calculations involved is not that big. The calculation of the Fourier transform is performed according to equation 5.

$$F ( u , v ) = \frac{1}{NM} {\sum }_{n = 1}^{I} {\sum }_{m = 1}^{J} V ( n , m ) {ⅇ}^{( - 2 π j ( \frac{u \cdot n}{N} + \frac{v \cdot m}{M} ) )} \qquad Ecuación 5$$

In a particular case where M=N=32, the equation is

$$F ( u , v ) = \frac{1}{{32}^{2}} {\sum }_{n = 1}^{32} {\sum }_{m = 1}^{32} V ( n , m ) {ⅇ}^{( - 2 π j ( \frac{u \cdot n + v \cdot m}{32} ) )}$$

Covering all the components of the variation V matrix, each one of the elements (u,v) of the F matrix is obtained. The F matrix is a matrix of complex numbers of, in the aforementioned particular case, 32×32. After generating this F matrix, another one is associated to it, MF, which contains the module of each element of the F matrix.

$$MF = ( \begin{matrix}{\vert F ( 1 , 1 ) \vert}^{2} & {\vert F ( 1 , 2 ) \vert}^{2} & ⋯ & {\vert F ( 1 , 32 ) \vert}^{2} \\ {\vert F ( 2 , 1 ) \vert}^{2} & {\vert F ( 2 , 2 ) \vert}^{2} & ⋯ & {\vert F ( 2 , 32 ) \vert}^{2} \\ ⋮ & ⋯ & ⋯ & ⋮ \\ ⋮ & ⋯ & ⋯ & ⋮ \\ ⋮ & ⋯ & ⋯ & ⋮ \\ {\vert F ( 32 , 1 ) \vert}^{2} & {\vert F ( 32 , 2 ) \vert}^{2} & ⋯ & {\vert F ( 32 , 32 ) \vert}^{2}\end{matrix} ) \qquad Ecuación 7$$

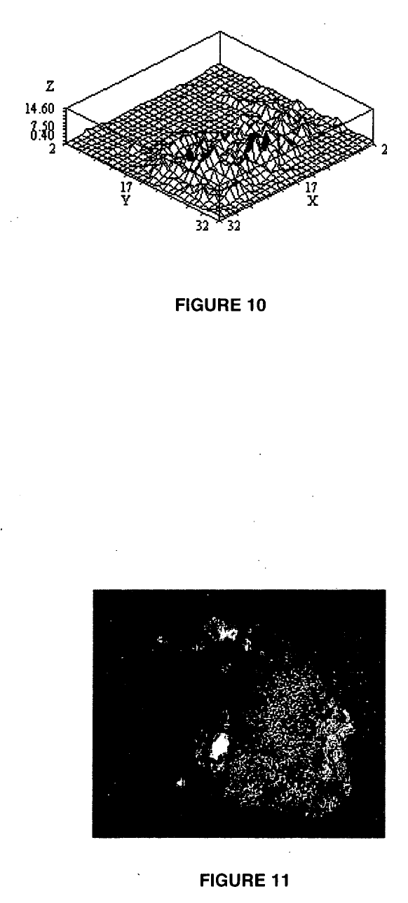

From the MF matrix graphic we obtain a three-dimensional representation very close in texture to the analyzed surface, as shown in FIG. 10.

Starting from this matrix it is possible to obtain the energy of the analyzed image. To evaluate such energy, the volume generated under the surface generated by the module of each element of the F matrix must be calculated. The energy of the image is proportional to the sum of the MF matrix elements since the integration step is constant.

$$E ∝ {\sum }_{m = 1}^{M} {\sum }_{n = 1}^{N} MF ( m , n ) \qquad Ecuación 8$$

This way it is possible to obtain, for the cathode surface image, the energy of its variation matrix.

From this indicator it is observed that given to an image without mayor tonality changes, the coefficients of its MF matrix will be small and therefore the energy of the variation matrix will be small, not so in the case that the image shows mayor tonality changes and rugosity, where the coefficients of the variation matrix modules will be big and therefore so will its energy.

1. A method of analysis and automatic visual inspection through digital images which operate on-line in the detection of imperfections in plain surfaces, preferably for the detection of physical imperfections in the surface of copper cathodes of EW, said method comprising the stages to capture an image of a plain surface through an image capture system, enhancing the characteristics of the image, extracting the characteristics of the image enhanced in the previous stage, so as to obtain the attributes of each image and classify said image attributes in order to determine the presence of imperfections in said surface, wherein said stage enhancing the characteristics of the image comprises the following operations:
b1) image brightness elimination, which consists in a point by point transformation over the image modifying the pixel values with respect to a level of gray near to white,
b2) noise elimination by means of bass-pass filters, which consists in softening the image, diminishing the high spatial frequencies, where said image is convoluted with a square filter of the type
$$LP = \frac{1}{9} [ \begin{matrix}1 & 1 & 1 \\ 1 & 1 & 1 \\ 1 & 1 & 1\end{matrix} ]$$
b3) enhance the borders through high-pass filters, which consists in the amplification of high frequencies within the image, where said image is convoluted with a square filter of the type
$$HP = [ \begin{matrix}0 & - 1 & 0 \\ - 1 & 5 & - 1 \\ 0 & - 1 & 0\end{matrix} ]$$

2. A method according to claim 1, wherein in said extraction of characteristics stage, the energy of said image is extracted as information characteristic of the texture of the surface of said analyzed image, in which said energy quantifies the dispersion of a set of pixels within said image with respect to its average value, in which said image is dimensioned in I×J pixels rows and columns and such dispersion is calculated using a σ/μ indicator.

3. A method according to claim 2, wherein said σ/μ indicator is calculated by the following equations:
$$μ = \frac{1}{IJ} {\sum }_{i = 1}^{I} {\sum }_{j = 1}^{J} {x}_{i , j}$$
$$σ = \sqrt{\frac{1}{IJ} {\sum }_{i = 1}^{I} {\sum }_{j = 1}^{J} {( {x}_{i , j} - μ )}^{2}}$$

4. A method according to claim 2, wherein said image of I×J dimensions is divided in S×R subimages of
$$\frac{I}{S} \times \frac{J}{R}$$
dimensions, which once divided, the σ/μ indicator is calculated to each subimage according to its position within the image, this position being σ_{m,n}/μ_{m,n}, in which each one of said values are stored in a matrix of S×R dimensions, in which said matrix is denominated variation matrix.

5. A method according to claim 4 wherein to said variation matrix, its bi-dimensional fourier transform is calculated as follows:
$$F ( u , v ) = \frac{1}{NM} {\sum }_{n = 1}^{N} {\sum }_{m = 1}^{M} V ( n , m ) {ⅇ}^{( - 2 π j ( \frac{u \cdot n}{N} + \frac{v \cdot m}{M} ) )} ,$$
in which by covering all the components of said variation matrix, each element (u,v) is obtained from said F(u,v) matrix.

6. A method according to claim 5 wherein to said F(u,v) matrix, a MF matrix is associated, which contains the module of each element of the F(u,v) matrix, in which the graphic of said MF matrix represents the texture of said plain surface three-dimensionally, and from the same the energy of the analyzed image is obtained, where the greater the energy the greater is the texture change in said plain surface.

7. Analysis and automatic visual inspection system through digital images operating on-line in the detection of imperfections in plain surfaces, preferably for the detection of physical imperfections in the surface of copper cathodes of EW wherein it comprises a light source over said plain surfaces and to illuminate them, a video camera, preferably digitally designed to receive the reflection generated by the lighting of such plain surfaces by means of said light source, a processor which performs the process and analysis of an image coming from the out-put of such video camera, in which said process and analysis is carried out according to the method of claims 1 to 6, providing an indicative parameter of the texture of said plain surfaces.

8. A system according to claim 7, wherein said light source is a Fresnel type spotlight, in which the beam of light generated by the same is directed towards said plain surface with an incidence angle of approximately 30°, in that for said purpose a fitting device of the incidence angle as well of spatial location has been placed in said light source.

9. A system according to claim 8, wherein said cameras are placed over said plain surface, in that for the activation of the system a position sensor has been integrated.

10. A system according to claim 8 wherein said camera out-put is digital and is connected to a image capture card which includes a memory for image storing.

11. A system according to claims 8 and 10 wherein said image capture card is an integral part of said processor.
